(19) United States
(12) Patent Application Publication
(10) Pub. No.: US 2008/0268292 A1
(43) Pub. Date: Oct. 30, 2008

(54) Hexagonal close-packed ceramic seedlayers for perpendicular magnetic recording media

(75) Inventors: Anirban Das, Chandler, AZ (US); Michael Gene Racine, Phoenix, AZ (US); Makoto Imakawa, Phoenix, AZ (US)

Correspondence Address: MCDERMOTT WILL & EMERY LLP, 18191 VON KARMAN AVE., SUITE 500, IRVINE, CA, 92612-7108, US

(73) Assignee: HERAEUS, INC., Chandler, AZ (US)

(21) Appl. No.: 11/790,541

(22) Filed: Apr. 26, 2007

(51) Int. Cl. G11B 5/66; B05D 5/12

(52) U.S. Cl. 428/831; 427/127; 427/132

(57) ABSTRACT

A magnetic recording medium is provided, comprising a substrate, a hexagonal close-packed seedlayer deposited over the substrate, a hexagonal close-packed underlayer deposited over the seedlayer, and a hexagonal close-packed recording layer deposited over the underlayer. The seedlayer is comprised of a ceramic. A method of manufacturing a magnetic recording medium is also provided, comprising the steps of sputtering a first sputter target to deposit a hexagonal close-packed seedlayer over a substrate, sputtering a second sputter target to deposit a hexagonal close-packed underlayer over the seedlayer, and sputtering a third sputter target to deposit a hexagonal close-packed magnetic recording layer over the underlayer. The seedlayer comprises a ceramic.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The present invention generally relates to magnetic recording media and, more particularly, perpendicular magnetic recording media with hexagonal close-packed (“HCP”) ceramic seedlayers.

### BACKGROUND OF THE INVENTION

To satisfy the continual demand for even greater data storage capacities, higher density magnetic recording media are required. Of the approaches to achieve this high data density, perpendicular magnetic recording (“PMR”) by far appears to be the most promising. To improve the performance of a magnetic recording layer in a PMR media stack, it is desirable to provide well-isolated fine grain structure coupled with large perpendicular magnetic anisotropy Kᵤ.

### SUMMARY OF THE INVENTION

The present invention provides a magnetic recording medium with a hexagonal close-packed (“HCP”) ceramic seedlayer, together with sputter targets for and methods of manufacturing the same. The use of a HCP ceramic seedlayer encourages the epitaxial growth of the subsequently-deposited HCP underlayer and HCP magnetic recording layer (e.g., each of the seedlayer, underlayer and magnetic recording layer will have columnar grains aligned along the same axis). This epitaxial growth improves the strong out-of-plane orientation of the [0002] axis of the recording layer, and accordingly improve its magnetocrystalline isotropy (“Kᵤ”) and its out-of-plane coercivity (“H_{c}”).

According to one embodiment of the present invention, a magnetic recording medium comprises a substrate, a hexagonal close-packed seedlayer deposited over the substrate, a hexagonal close-packed underlayer deposited over the seedlayer, and a hexagonal close-packed recording layer deposited over the underlayer. The seedlayer is comprised of a ceramic.

According to one aspect of the present invention, a method of manufacturing a magnetic recording medium comprises the steps of sputtering a first sputter target to deposit a hexagonal close-packed seedlayer over a substrate, sputtering a second sputter target to deposit a hexagonal close-packed underlayer over the seedlayer, and sputtering a third sputter target to deposit a hexagonal close-packed magnetic recording layer over the underlayer. The seedlayer comprises a ceramic.

It is to be understood that both the foregoing summary of the invention and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a magnetic recording medium according to one embodiment of the present invention;

FIG. 2 illustrates a sputter target in accordance with one embodiment of the present invention; and

FIG. 3 is a flowchart illustrating a method for manufacturing a magnetic recording medium according to one aspect of the present invention.

### DETAILED DESCRIPTION OF THE INVENTION

In the following detailed description, numerous specific details are set forth to provide a full understanding of the present invention. It will be apparent, however, to one ordinarily skilled in the art that the present invention may be practiced without some of these specific details. In other instances, well-known structures and techniques have not been shown in detail to avoid unnecessarily obscuring the present invention.

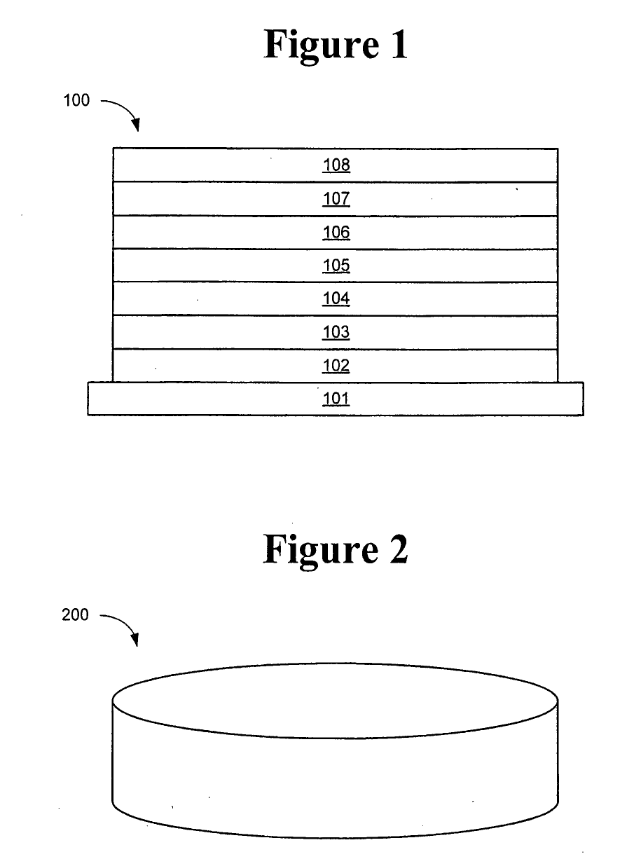

FIG. 1 illustrates a magnetic recording media stack 100 according to one embodiment of the present invention. Media stack 100 includes a substrate 101 (e.g., glass or aluminum), on which a number of thin films are deposited, such as a seedlayer 104, an underlayer 105 and a magnetic recording layer 106. Magnetic recording layer 106 is a hexagonal close-packed (“HCP”) granular magnetic media, such as, for example, a CoCrPt-based alloy. The performance (e.g., as indicated by the magnetocrystalline anisotropy Kᵤ and the out-of-plane coercivity H_{c}) of magnetic recording layer 106 is strongly dependent upon the orientation of the magnetic easy axis thereof, which, for a HCP Co-based alloy, is the [0002] crystallographic direction. Strong texturing of the [0002] planes parallel to the surface of magnetic recording layer 106 is achieved by depositing HCP magnetic recording layer 106 on an HCP metal- or metal alloy-based underlayer. Accordingly, underlayer 105 is also an HCP layer, such as, for example, a layer comprised of ruthenium (“Ru”), rhenium (“Re”), titanium (“Ti”), or alloys thereof.

In accordance with one aspect of the present invention, to improve the texturing of the [0002] planes parallel to the surface of HCP underlayer 105 (and thereby improve the texturing of the [0002] planes parallel to the surface of HCP magnetic recording layer 106), HCP underlayer 105 is deposited on a seedlayer 104 which is comprised of a HCP ceramic material. The HCP ceramic of seedlayer 104 is thermodynamically stable and less reactive with the material of underlayer 105 than face-centered cubic (“FCC”) or body-centered cubic (“BCC”) crystalline metal or metal alloy seedlayers.

According to one aspect of the present invention, the ceramic material of seedlayer 104 may be any ceramic material, where “ceramic” refers to as any inorganic non-metallic material. For example, ceramic materials such as oxides, borides, carbides, nitrides, or any combination thereof may be used as the ceramic material for HCP seedlayer 104. Common ceramic structures in which the anions are hexagonally close packed include Corundum, Wurtzite and nickel arsenide structures. Table 1, below, provides an exemplary list of ceramic materials suitable for use as a HCP seedlayer in accordance with various embodiments of the present invention.

TABLE 1

| | Crystal | a-Axis Lattice |
|---|---|---|
| Material | Structure | Parameter (Å) |
| Oxides: | | |
| TiO₂ | Hexagonal (Rutile) | |
| Al₂O₃ | Hexagonal (Corundum) | 5.59 |
| V₂O₃ | Hexagonal (Corundum) | |
| Carbides: | | |
| WC | Hexagonal | 2.91 |
| SiC | Hexagonal (Wurtzite) | 3.08 |
| Nitrides: | | |
| BN | Hexagonal | 2.5 |
| AlN | Hexagonal (Wurtzite) | 3.11 |
| Borides: | | |
| TiB₂ | Hexagonal | 3.03 |

In accordance with one aspect of the present invention, the use of a HCP ceramic material for seedlayer 104 encourages the epitaxial growth of the subsequently-deposited HCP underlayer 105 and HCP magnetic recording layer 106. Accordingly, in one embodiment of the present invention, HCP ceramic seedlayer 104, HCP underlayer 105 and HCP magnetic recording layer 106 are epitaxially deposited (e.g., each of the seedlayer, underlayer and magnetic recording layer has columnar grains aligned along the same axis).

According to various aspects of the present invention, a HCP ceramic seedlayer enjoys a number of benefits when compared to traditional BCC or FCC metal and metal alloy seedlayers. For example, cubic tantalum (“Ta”) seedlayers need to be about 20 nm in thickness to avoid being undesirably amorphous (and thereby reducing the out-of-plane orientation of the [0002] direction in the subsequently-deposited underlayer). In contrast, according to one aspect of the present invention, a HCP ceramic seedlayer of the present invention may be less than 20 nm, while still providing strong out-of-plane orientation of the [0002] direction in the underlayer. For example, in various embodiments of the present invention, the HCP ceramic seedlayer may be provided in any of a number of thicknesses less than 20 nm, such as 5 nm, 10 nm, 15 nm, etc.

According to an additional aspect of the present invention, the ceramic material of HCP seedlayer 104 has an a-axis lattice parameter of between about 2.0 and 3.7 angstrom (Å), in order to provide close lattice matching with underlayer 105. For example, in an embodiment in which underlayer 105 is a Ru HCP thin film, the a-axis lattice parameter of underlayer 105 would be about 2.7 Å. Accordingly, a tungsten-carbide (“WC”) seedlayer 104 with an a-axis lattice parameter of 2.91 Å would provide a very close lattice match.

While the foregoing exemplary embodiment has been described with reference to HCP ceramic seedlayers with a-axis lattice parameters between 2.0 Å and 3.7 Å, the scope of the present invention is not limited to such an arrangement. Rather, the present invention has application to HCP ceramic seedlayers with any a-axis lattice parameter. For example, if a subsequently-deposited underlayer has an a-axis lattice parameter of 5.0 Å, the a-axis lattice parameter of the HCP ceramic seedlayer may be between 3.7 Å and 6.3 Å. As will be immediately apparent to one of skill in the art, a HCP ceramic seedlayer of the present invention may have any a-axis lattice parameter suitable for providing close lattice matching with a subsequently-deposited underlayer of any material and/or a-axis lattice parameter.

According to one embodiment of the present invention, the ceramic material of seedlayer 104 is a non-magnetic or weakly-magnetic material. For example, in accordance with one aspect of the present invention, seedlayer 104 may have a mass susceptibility of less than 10⁻⁶ m³/kg.

A media stack such as media stack 100 may also include one or more soft underlayers with or without other non-magnetic or magnetic layers, such as layers 102 and 103, between seedlayer 104 and substrate 101. Even in such an arrangement, seedlayer 104 is referred to as being deposited “over” substrate 101. Similarly, a media stack such as media stack 100 may further include a lube layer and a carbon overcoat with or without other magnetic or non-magnetic layers, such as layers 107 and 108, above magnetic recording layer 106.

Turning to FIG. 2, a sputter target 200 is illustrated according to one embodiment of the present invention. Sputter target 200 may be used to sputter a thin film for use in a magnetic recording media, such as seedlayer 104. According to one embodiment of the present invention, sputter target 200 is made up of a HCP ceramic material (e.g., a material listed in Table 1) for sputtering a HCP ceramic seedlayer which promotes epitaxial growth of subsequently-deposited underlayers and magnetic recording layers. According to one aspect, the ceramic material of sputter target 200 may be any inorganic non-metallic material, such as an oxide, a boride, a carbide, a nitride, or any combination thereof. Additionally, in accordance with one aspect of the present invention, the ceramic material has an a-axis lattice parameter between about 2.0 Å and 3.7 Å, to provide good lattice matching with a subsequently deposited Ru—, Re— or Ti-based underlayer. In accordance with yet another aspect of the present invention, the ceramic material is non-magnetic, and has a mass susceptibility of less than 10⁻⁶ m³/kg.

In the sputtering process, sputter target 200 is positioned in a sputtering chamber, which is partially filled with an inert gas. Sputter target 200 is exposed to an electric field to excite the inert gas to generate plasma. Ions within plasma collide with a surface of sputter target 200 causing molecules to be emitted from the surface of sputter target 200. A difference in voltage between sputter target 200 and the surface to be coated (e.g., a substrate such as substrate 101) causes the emitted molecules to form the desired film on the surface to be coated.

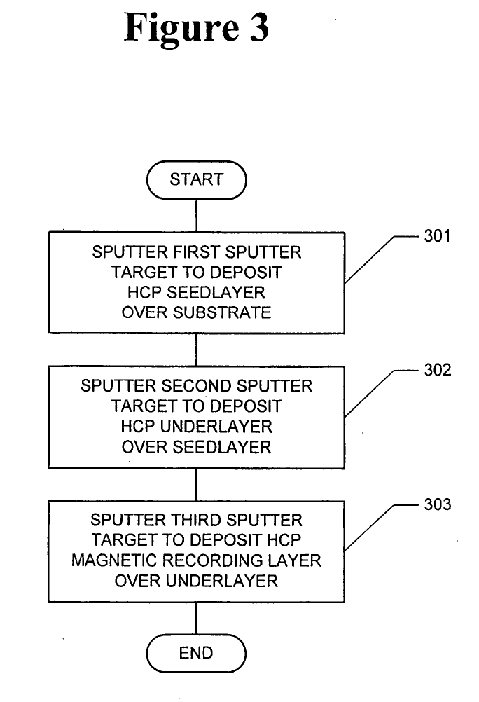

FIG. 3 is a flowchart illustrating a method for manufacturing a magnetic recording medium according to one aspect of the present invention. The method begins with step 301, in which a first sputter target is sputtered to deposit a HCP ceramic seedlayer over a substrate. The ceramic material of the HCP ceramic seedlayer may be any inorganic non-metallic material, such as an oxide, a boride, a carbide, a nitride, or any combination thereof. Additionally, in accordance with one aspect of the present invention, the ceramic material has an a-axis lattice parameter between about 2.0 Å and 3.7 Å, to provide good lattice matching with a subsequently deposited Ru—, Re— or Ti-based underlayer. In accordance with yet another aspect of the present invention, the ceramic material is non-magnetic or weakly-magnetic (e.g., with a mass susceptibility of less than 10⁻⁶ m³/kg).

The process continues in step 302, in which a second sputter target is sputtered to deposit a HCP underlayer over the HCP ceramic seedlayer deposited in step 301. According to one aspect of the present invention, the second sputter target is a HCP metal or metal alloy sputter target. For example, the second sputter target (and accordingly, the HCP underlayer) is comprised of Ru, Re, Ti, or alloys thereof. The process continues in step 303, in which a third sputter target is sputtered to deposit a HCP magnetic recording layer over the HCP underlayer deposited in step 302. The third sputter target may be a Co—, CoCr—, CoPt— or CoCrPt-based alloy. According to one aspect of the present invention, the third sputter target is reactively sputtered in the presence of oxygen, to form a granular magnetic media.

While the foregoing exemplary embodiment has been described with reference to underlayers comprised of Ru, Re, Ti or alloys thereof, the scope of the present invention is not limited to these particular arrangements. Rather, as will be readily apparent to those of skill in the art, the present invention has application to magnetic recording media with underlayers comprised of any material or combinations of materials. Similarly, while the foregoing exemplary embodiment has been described with reference to magnetic recording layers comprised of Co—, CoCr—, CoPt— or CoCrPt-based alloys, the scope of the present invention is not limited to these particular arrangements. Rather, as will be readily apparent to those of skill in the art, the present invention has application to magnetic recording media with magnetic recording layers comprised of any material or combinations of materials.

According to one aspect of the present invention, the ceramic material of the seedlayer has a negative (i.e., <0) Gibbs free energy at the temperature at which the second sputter target is sputtered (e.g., at temperatures between about 20° C. and 400° C.). This thermodynamic stability will prevent undesirable intermediate phases from forming as a result of interfacial reactions at the interface between the seedlayer and the underlayer during the sputtering of the magnetic recording medium.

While the present invention has been particularly described with reference to the various figures and embodiments, it should be understood that these are for illustration purposes only and should not be taken as limiting the scope of the invention. There may be many other ways to implement the invention. Many changes and modifications may be made to the invention, by one having ordinary skill in the art, without departing from the spirit and scope of the invention.

What is claimed is:

1. A magnetic recording medium, comprising:
a substrate;
a hexagonal close-packed seedlayer deposited over the substrate, the seedlayer being comprised of a ceramic;
a hexagonal close-packed underlayer deposited over the seedlayer; and
a hexagonal close-packed recording layer deposited over the underlayer.

2. The magnetic recording medium of claim 1, wherein the seedlayer, the underlayer and the recording layer are epitaxial.

3. The magnetic recording medium of claim 1, wherein each of the seedlayer, the underlayer and the recording layer comprises columnar grains.

4. The magnetic recording medium of claim 1, wherein the ceramic is selected from the group consisting of an oxide, a boride, a nitride, a carbide, and any combination thereof.

5. The magnetic recording medium of claim 1, wherein the ceramic is selected from the group consisting of TiO₂, Al₂O₃, V₂O₃, WC, SiC, BN, AlN and TiB₂.

6. The magnetic recording medium of claim 1, wherein the ceramic has a mass susceptibility of less than 1×10⁻⁶ m³/kg.

7. The magnetic recording medium of claim 1, wherein the seedlayer has an a-axis lattice parameter between 2 and 3.7 angstroms.

8. The magnetic recording medium of claim 1, wherein the seedlayer has an a-axis lattice parameter of about 2.7 angstroms.

9. The magnetic recording medium of claim 1, wherein the seedlayer is less than 20 nm thick.

10. The magnetic recording medium of claim 1, further comprising a soft underlayer disposed between the substrate and the hexagonal close-packed seedlayer.

11. A method of manufacturing a magnetic recording medium, the method comprising the steps of:
sputtering a first sputter target to deposit a hexagonal close-packed seedlayer over a substrate, wherein the seedlayer comprises a ceramic;
sputtering a second sputter target to deposit a hexagonal close-packed underlayer over the seedlayer; and
sputtering a third sputter target to deposit a hexagonal close-packed magnetic recording layer over the underlayer.

12. The method according to claim 11, wherein the seedlayer, the underlayer and the recording layer are epitaxially deposited.

13. The method according to claim 11, wherein the ceramic is selected from the group consisting of an oxide, a boride, a nitride, a carbide, and any combination thereof.

14. The method according to claim 11, wherein the ceramic is selected from the group consisting of TiO₂, Al₂O₃, V₂O₃, WC, SiC, BN, AlN and TiB₂.

15. The method according to claim 11, wherein the ceramic has a mass susceptibility of less than 1×10⁻⁶ m³/kg.

16. The method according to claim 11, wherein the step of sputtering the second sputter target occurs at a sputtering temperature between 20° C. and 400° C.

17. The method according to claim 16, wherein the ceramic has negative Gibbs free energy at the sputtering temperature.

18. The method according to claim 11, wherein the seedlayer has an a-axis lattice parameter between 2 and 3.7 angstroms.

19. The method according to claim 11, wherein the seedlayer has an a-axis lattice parameter of about 2.7 angstroms.

20. The method according to claim 11, wherein the seedlayer is less than 20 nm thick.
